(19) United States
(12) Patent Application Publication
(10) Pub. No.: US 2006/0086028 A1
(43) Pub. Date: Apr. 27, 2006

(54) Tags and methods of forming and using such tags

(76) Inventor: John Vaughan, Newport Beach, CA (US)

Correspondence Address: CHRISTIE, PARKER & HALE, LLP, PO BOX 7068, PASADENA, CA, 91109-7068, US

(21) Appl. No.: 11/259,820

(22) Filed: Oct. 26, 2005

Related U.S. Application Data
(60) Provisional application No. 60/622,299, filed on Oct. 26, 2004.

(51) Int. Cl. G09F 3/14

(52) U.S. Cl. 40/665

(57) ABSTRACT

A tag, a method of forming such a tag and a method of using such a tag to band together produce are provided. The tag is formed by folding a sheet of material over an elastic band forming a tunnel penetrated by the band.

### CROSS-REFERENCE TO RELATED APPLICATION

This application is based upon and claims priority on U.S. Provisional Application No. 60/622,299, filed on Oct. 26, 2004, the contents of which are fully incorporated herein by reference.

### BACKGROUND OF THE INVENTION

A tag incorporating a band that is easily attachable to produce by use of the band, a method of forming such tag as well as a method of using such tag are provided. Various apparatus and methods are used to tag and hold various produce together. Some of these apparatuses are used in automated processes for banding together and tagging produce. A drawback with most tags used to tag and bond together produce are complexities in the manufacture and application of such tags. Consequently, a tag is required that is relatively easy to manufacture and easy to be applied to produce.

### SUMMARY OF THE INVENTION

A tag, a method of forming such a tag and a method of using such a tag to band produce together are provided. In one exemplary embodiment a tag is provided. The tag includes an elastic band. A tag material sheet is folded over the band and bonded to itself forming the tag and defining a tunnel penetrated by the band. The tunnel has a length as measured along a width of the tag, which length is at least as long as the width of the tab. In an exemplary embodiment, the material sheet has a thickness of 2.6 mils. In another exemplary embodiment, the material sheet is made of polypropylene. In yet another exemplary embodiment, when folded over, the material sheet defines a tag front panel and a tag rear panel opposite the front panel and bonded to a rear surface of front panel, where the rear panel occupies a majority of the rear surface of the front panel. In yet another exemplary embodiment, the rear panel occupies the entire the rear surface of the front panel. In a further exemplary embodiment, the tag includes a first linear edge opposite a second linear edge and the tunnel extends from the first edge to the second edge. In yet another exemplary embodiment, the elastic band is rubber band. In yet a further exemplary embodiment, the band extends from one end of the tunnel externally to the other end of the tunnel and through the tunnel.

In another exemplary embodiment, a method of forming a tag for tagging and banding produce is provided. The method includes providing an elastic band, providing a sheet of material having a first linear edge opposite a second linear edge, folding the sheet over the band defining a tunnel penetrated by the band and a first sheet panel opposite a second sheet panel, where the tunnel extends from the first edge to the second edge, and bonding the first sheet panel to the second sheet panel. In another exemplary embodiment, folding includes folding the sheet in half. In yet a further exemplary embodiment, the sheet provided is made from polypropylene. In yet another exemplary embodiment, the sheet provided has a thickness of 2.6 mils. In one exemplary embodiment, the sheet has a sufficient width as measured between the first and second edges to accommodate a universal produce code (“UPC”). In another exemplary embodiment the sheet has a sufficient length as measured perpendicularly relative to the tunnel to accommodate a UPC. In yet a further exemplary embodiment, the method further includes using the band to band together a plurality of produce. In another an exemplary embodiment, the sheet is folded over a portion of the band such that the band extends continuously and externally from one end of the tunnel to the other end of the tunnel and through the tunnel.

### BRIEF DESCRIPTION OF THE DRAWINGS

FIG. 1 is a front view of an exemplary tag of the present invention.

FIG. 2 is an end view of an exemplary tag of the present invention.

FIG. 3 is a front view of an exemplary tag of the present invention used to tag and retain together a plurality of carrots.

### DETAILED DESCRIPTION OF THE INVENTION

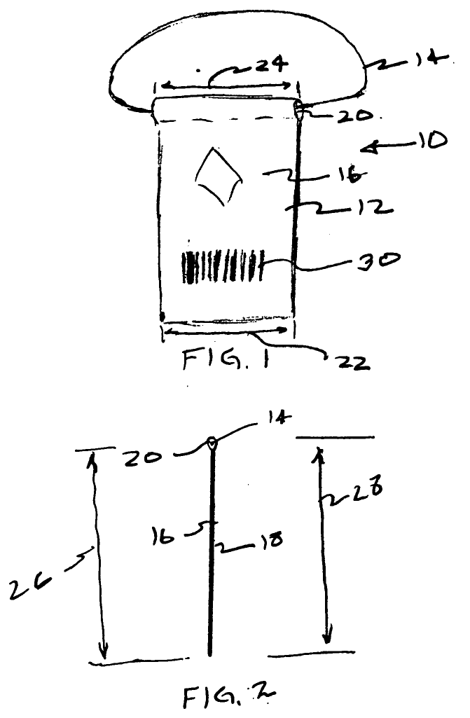

The present invention is directed to a tag that incorporates a band and that is easily attachable to produce by use of the band. The tag with band also serve to hold the tagged produce together. In an exemplary embodiment, shown in FIG. 1, the tag 10 includes a label portion 12 and a band 14. The band 14 in an exemplary embodiment is a rubber band. However, the band may be any elastic material forming a loop.

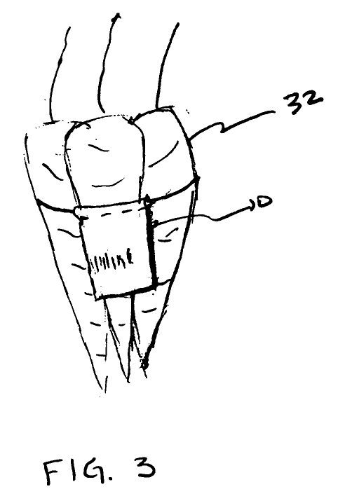

The label may be made from various materials, for example, plastic or paper. In an exemplary embodiment, the label is made from a plastic material, such as polypropylene, so as to be waterproof and tear resistant. The exemplary embodiment label is formed by folding a plastic sheet of material on to itself so as to form a front face 16 and a rear face 18, as for example shown in FIG. 2. The sheet of material is folded over the band so as to form a tunnel 20 which is penetrated by the band 14. The rear face 18 is then adhered to the front face 16.

In an exemplary embodiment the width 22 of the tag and the length 24 of the tunnel are the same. Furthermore, the rear face 18 occupies a majority of the rear of the front face 16 area. In a further exemplary embodiment, the front face area and the rear face area are the same. In other words, the sheet forming the tag is folded in half and on to itself such that the length 26 of the front face and the length 28 of the rear face are the same. In this regard the stiffness of the label is increased providing a better surface for displaying information about the product being tagged, as well as a conventional universal produce code (“UPC”) 30, if needed, as for example, shown in FIG. 1. Furthermore, by being stiffer, the label remains relatively flat making it easier for a scanner to scan the UPC. In an exemplary embodiment, a sheet of polypropylene having a thickness of 2.6 mils is used such that when it is folded over it forms a tag having a thickness of about 5.2 mils. A mil is equal to 0.001 inch. Applicant has discovered that a polypropylene sheet having a thickness of 2.6 mils form a tag with sufficient thickness for remaining relatively flat for facilitating easier scanning of the UPC when such code in printed on the tag.

Moreover, a thinner less stiff and at times less expensive material may be used to form the label, since when the label is folded such that the rear face of the label occupies at least the majority of the entire area of the rear of the front face of the label, the stiffness of the label is increased and the overall label becomes thicker (i.e., the label thickness is twice that of the sheet) and thus, stronger.

In an exemplary embodiment, the width 22 of the tag is sufficient for accommodating a UPC. In another exemplary embodiment, the length 28 of the tag is sufficient for accommodating a UPC. The tag may be used to band together a plurality of produce, as for example, carrots as shown in FIG. 3.

The preceding description has been presented with reference to exemplary embodiments of the invention. Persons skilled in the art and technology to which this invention pertains will appreciate that alterations and changes in the described structures and methods of operation can be practiced without meaningfully departing from the principal, spirit and scope of this invention. Accordingly, the foregoing description should not be read as pertaining only to the precise structures and methods described and shown in the accompanying drawings.

1. A tag for tagging produce comprises:
an elastic band;
a tag material sheet folded over the band and bonded to itself forming the tag and defining a tunnel penetrated by the band, wherein the tunnel has a length as measured along a width of the tag, wherein the tunnel length is at least as long as the width of the tab.

2. The tag as recited in claim 1 wherein the material sheet has a thickness of 2.6 mils.

3. The tag as recited in claim 1 wherein the material sheet comprises polypropylene.

4. The tag as recited in claim 1 wherein when folded over, the material sheet defines a tag front panel and a tag rear panel opposite the front panel and bonded to a rear surface of front panel, wherein the rear panel occupies a majority of the rear surface of the front panel.

5. The tag as recited in claim 1 wherein when folded over, the material sheet defines a tag front panel and a tag rear panel opposite the front panel and bonded to a rear surface of front panel, wherein the rear panel occupies the entire the rear surface of the front panel.

6. The tag as recited in claim 1 wherein the tag comprises a first edge opposite a second edge, wherein the tunnel extends from the first edge to the second edge and wherein each of the first and second edges is linear.

7. The tag as recited in claim 1 wherein the elastic band is rubber band.

8. The tag as recited in claim 1 wherein the band extends from one end of the tunnel externally to the other end of the tunnel and through the tunnel.

9. A method of forming a tag for tagging and banding produce, the method comprising:
providing an elastic band;
providing a sheet of material having a first edge opposite a second edge, wherein both the first and second edges are linear;
folding the sheet over the band defining a tunnel penetrated by the band and a first sheet panel opposite a second sheet panel, said tunnel extending from the first edge to the second edge; and
bonding the first sheet panel to the second sheet panel.

10. The method as recited in claim 9 wherein folding comprises folding the sheet in half.

11. The method as recited in claim 9 wherein providing a sheet comprises providing a polypropylene sheet of material.

12. The method as recited in claim 11 wherein providing a sheet comprises providing a sheet having a thickness of 2.6 mils.

13. The method as recited in claim 9 wherein providing a sheet comprises providing a sheet having a thickness of 2.6 mils.

14. The method as recited in claim 9 wherein providing a sheet comprises providing a sheet having a sufficient width as measured between the first and second edges to accommodate a UPC.

15. The method as recited in claim 9 wherein providing a sheet comprises providing a sheet having a sufficient length as measured perpendicularly relative to the tunnel to accommodate a UPC.

16. The method as recited in claim 9 further comprising using the band to band together a plurality of produce.

17. The method as recited in claim 9 wherein folding comprises folding the sheet over a portion of the band such that the band extends continuously and externally from one end of the tunnel to the other end of the tunnel and through the tunnel.
